(19) United States
(12) Patent Application Publication
(10) Pub. No.: US 2016/0025034 A1
(43) Pub. Date: Jan. 28, 2016

(54) TWO-PIECE PISTON FOR INTERNAL COMBUSTION ENGINE (DOUBLE JOINED)

(71) Applicant: KS KOLBENSCHMIDT GMBH, Neckarsulm (DE)

(72) Inventor: Klaus Lormes, Bad Wimpfen (DE)

(21) Appl. No.: 14/776,814

(22) PCT Filed: Feb. 13, 2014
(86) PCT No.: PCT/EP2014/052817

§ 371 Date: Sep. 15, 2015

(30) Foreign Application Priority Data
Mar. 15, 2013 (DE) 10 2013 204 629.4
Sep. 19, 2013 (DE) 10 2013 218 764.5

(51) Int. Cl. F02F 3/00; B23P 15/10; F02F 3/22

(52) U.S. Cl. CPC F02F 3/0015; F02F 3/22; B23P 15/10

(57) ABSTRACT

A piston in particular, a gallery cooled piston, of an internal combustion engine, includes at least one bottom part and at least one top part wherein the at least two piston parts have geometries which correspond in a connecting region in order to bring about a positively locking connection. A method for producing such a piston.

### BACKGROUND

This disclosure relates to a piston, specifically a cooling gallery piston, for an internal combustion engine and a method for producing the piston.

Following its final machining, the piston consists of one piece and comprises at least two pieces; such as exactly two pieces for example, that are produced separately and subsequently joined.

Ordinarily the two pieces (upper part and lower part) are produced in separate processes, such as forging, casting or similar and are then joined using a welded or soldered joint. DE 10 2010 05 220 A1, for example, describes a first piston component that is simple to manufacture, for example by casting, that can be joined to the second piston component, such as by means of friction welding.

Placement of a locating pin as an anti-rotation device between the piston skirt and the piston crown is described in disclosure DE 22 12 922. The piston skirt and piston crown are joined by means of a threaded connection. The disadvantage is the additional operating step to insert the anti-rotation device and the costly threaded connector.

EP 1 878 902 A2 describes the construction of a piston consisting of an upper part and a lower part that are supported by connecting ribs in the area of contact zones and are joined to each other. A clamped connection is created by rotation of the upper part relative to the lower part, comparable to a clutch. Handling is extremely complicated.

It would be desirable to implement the joining of upper part and lower part by means of a joining process that differs from a welding or soldering process.

### SUMMARY

Provision is made for the at least two piston parts to have corresponding geometries in their connecting area in order to effect a positive locking connection. Provision is further made for both parts to be joined permanently to form a single-piece piston using a positive lock. The positive lock and the correspondingly shaped areas of the upper part and the lower part, which form the positive lock, are shaped such that the two parts are joined permanently and inseparably after the positive locking procedure has been completed. Because components in a piston for an internal combustion engine consist of a metal material (for example, steel, aluminum or similar), it may be necessary for at least those areas that are required for the positive lock, but also for the entire upper part and the entire lower part, to be heated to a temperature considerably higher than ambient temperature before joining. The positive-locking connection between the lower part and the upper part is made unidirectionally. One direction facilitates handling and permits faster cycle times.

In one aspect, those areas of the upper part and of the lower part that face each other before joining and that ultimately form the positive lock are configured as a dovetail groove and a correspondingly configured tongue.

A connection is disclosed in which the at least two components to be joined interlock mechanically. The connection is permanent because of the geometric shape of the components to be connected in the joint area is designated as a positive lock. Even if no transfer of force results between the components to be joined, or the transfer of force between the components to be joined is interrupted, the join remains intact. Joins with an undercut, riveted joins or dovetail joins, for example, are counted among positive lock joints.

The terms dovetail shape or joint are chosen if, when viewed in cross-section, the shape of the tongue, or the groove, remotely resembles the forked shape of the tail of a swallow. In other words, if the geometry of the tongue, or the groove, in cross-section resembles a trapezoid, a plane quadrangle with two sides parallel to each other.

The geometry of the tongue in cross-section can be further conceived of as a triangle with its apex attached to the element to be connected, specifically an equilateral triangle. The groove then has a corresponding, matching cross-sectional shape to receive the tongue.

Pistons, and gallery-cooled pistons in particular, for an internal combustion engine include at least one lower part and at least one upper part, wherein the at least two piston parts have matching geometries in the area where the at least two piston parts are joined in order to effect a positive-locking connection. This creates a robust connection between the at least one lower part of a piston and the at least one upper part of a piston which meets the requirements for use in an internal combustion engine and satisfies long-term operating conditions.

Provisions can be made in the piston for matching geometries to be designed as a tongue and groove. The result is to create a secure, positive-locking connection since the groove preferably has an undercut that is engaged by the tongue. The requisite geometries involved can be produced in volume at an acceptable cost.

Provisions can also be made regarding the piston for the tongue to have the profile of a tongue matching the groove, at least after being joined. In this respect, it is conceivable that the tongue already has the profile of the groove before the at least two piston parts are joined. At this point a temporary, such as a plastic deformation of the tongue, takes place during the joining process. In a further aspect, the tongue does not assume the shape of the groove until the joining process. Manufacturing tolerances can be compensated for at this point because the precise geometry of the fastening elements is created only during the joining process. In both instances described, a robust, positive-locking connection is created between the at least one lower part and the at least one upper part of the piston.

Provision can be made regarding the piston for the groove to have the negative of a dovetail profile in cross-section. This results in undercuts that can be engaged securely by the tongue. The result is thus a load-bearing, positive-locking joint.

Provision can also be made regarding the piston for the groove to have a dovetail profile in cross-section, at least after joining. Before joining, the shape of the tongue in cross-section may diverge from the shape of the groove. After joining the tongue almost, or completely fills the groove.

Provision is made regarding the piston for the lower part and upper part to be joined permanently and inseparably following completion of the positive-locking process. Single-piece pistons are produced in one joining step, which can be carried out at high cycle times. There is no additional introduction of heat into the material that could lead to a change in the microstructure within the alloy, or within the metal. The properties of the original material remain completely intact.

A method for producing a positive-locking joint between lower part and upper part of a piston, specifically a gallery-cooled piston, for an internal combustion engine, is disclosed wherein a positive-locking connection is produced unidirectionally in one step. The connection is produced reliably even with rapid cycle times. The joining process can be monitored using documentation of force during the joining. Costly subsequent monitoring of the joint site, such as is required with a material-to-material connection, can be dispensed with. Complexity and costs for handling tools are reduced because only a single joining direction has to be implemented.

The method makes provision for at least one part, either upper part or lower part, to be heated to a considerably higher temperature than ambient temperature prior to joining. In order to facilitate the joining process, one of the parts to be joined can be heated before being assembled. If tongue and grooves have different geometries before being joined, heating one component facilitates finding the new shape for the tongue.

The method makes provision for the tongue to assume the geometry of the groove during the joining process. This creates a lash-free, positive-locking connection.

The method makes provision for an inseparable, at least positive-locking connection between the lower part and the upper part of a piston to be created by hot forming. The joint between the at least one lower part and the at least one upper part of the piston is configured such that it cannot become detached during operation of an internal combustion engine.

The positive lock is configured such that it counters the forces to which it is exposed during operation in an internal combustion engine. These are primarily forces whose vector runs parallel to the central longitudinal axis of the piston.

### DETAILED DESCRIPTION OF THE DRAWING

More precise details of the two piece piston and method of making the piston are explained in conjunction with following the drawing in which:

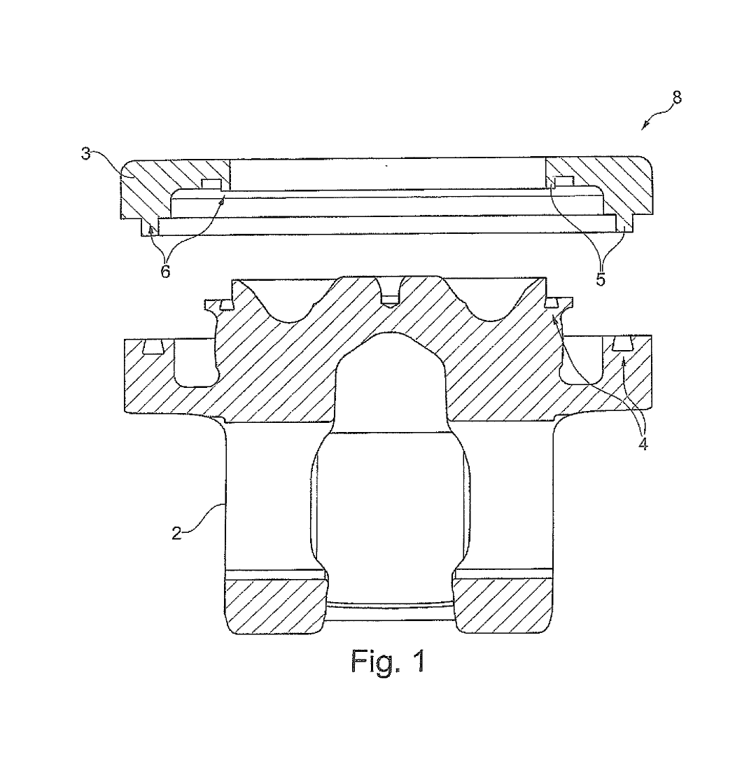

FIG. 1 is a cross-sectional view of a two-piece piston prior to joining;

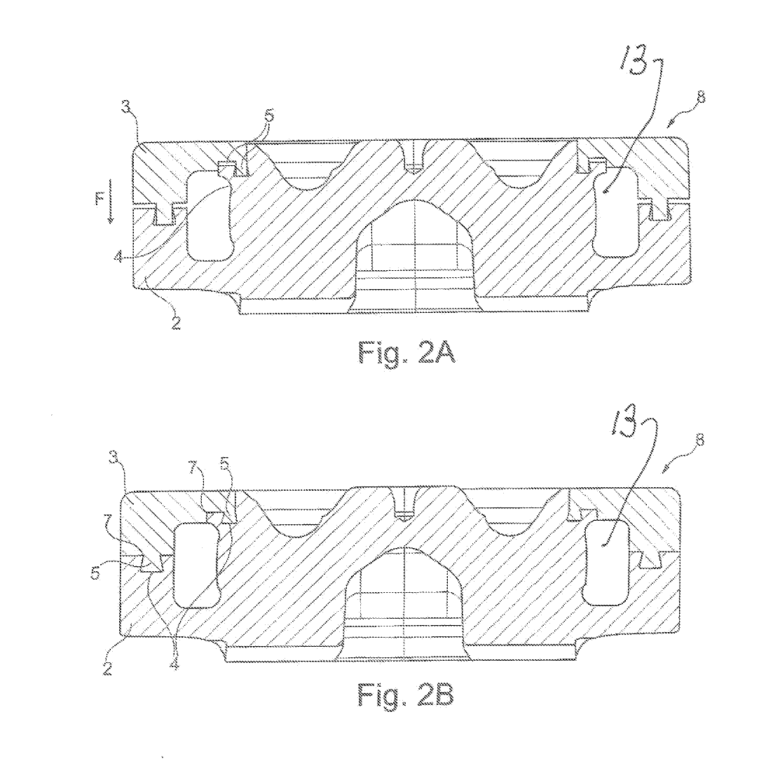

FIGS. 2A and 2B are cross-sectional views before and after, respectively;

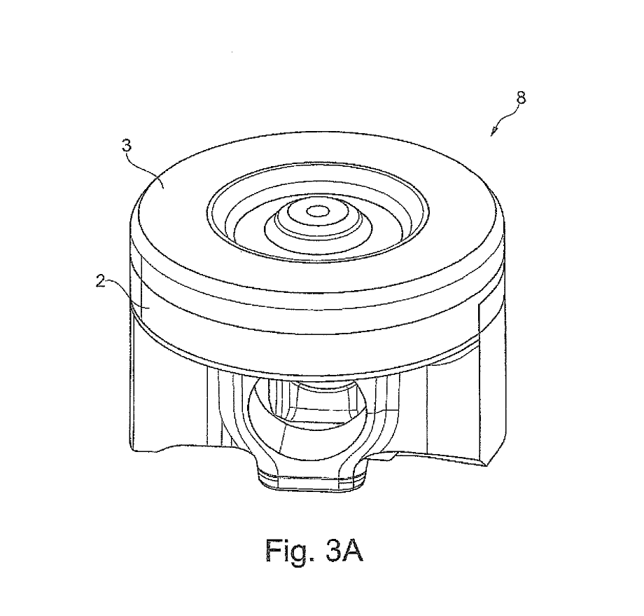

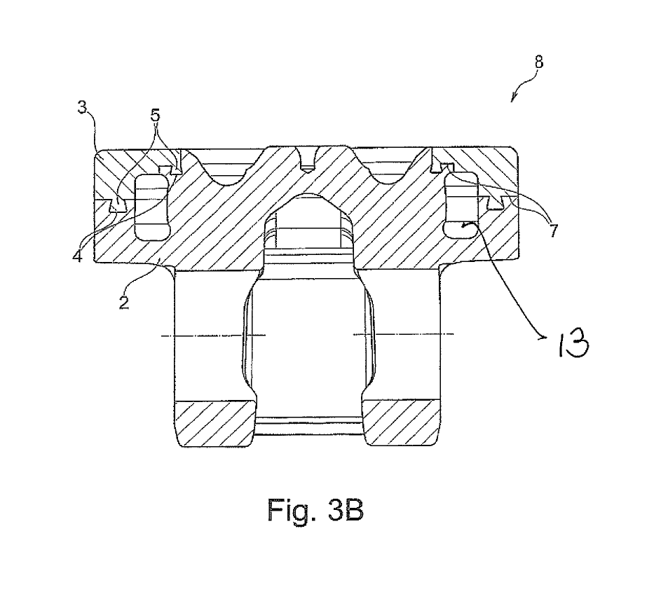

FIGS. 3A and 3B are perspective and cross sectional views, respectively, of a joined piston blank;

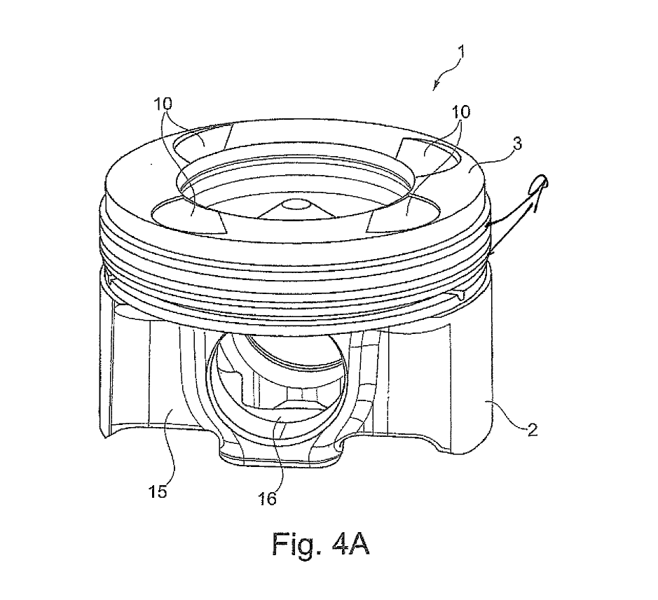

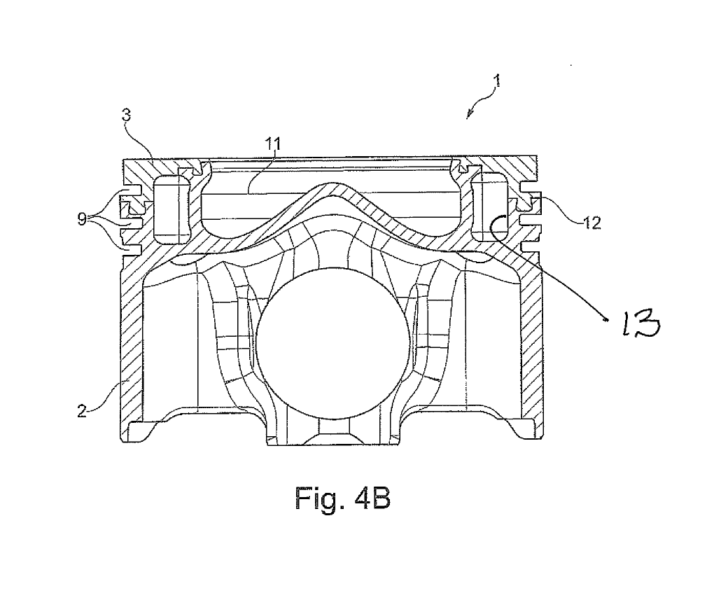

FIGS. 4A and 4B is a perspective view of a finished piston and a cross-sectional view of a finished piston;

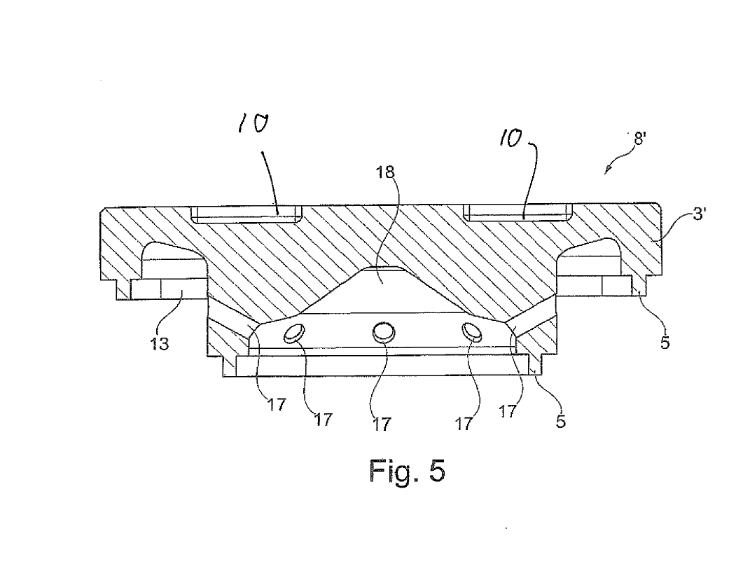

FIG. 5 shows a further embodiment of a piston upper part (commercial vehicle piston) as a cross-sectional view;

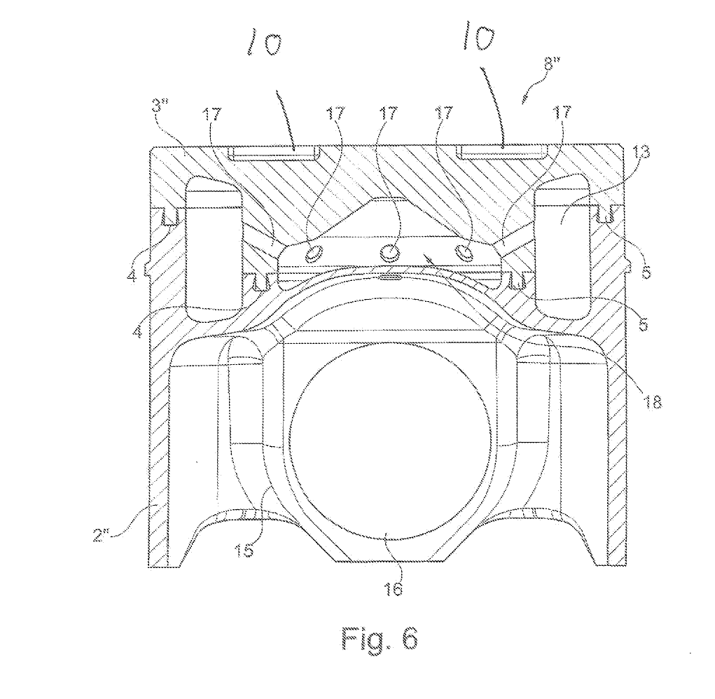

FIG. 6 shows a cross-sectional view after joining the piston from FIG. 5; and

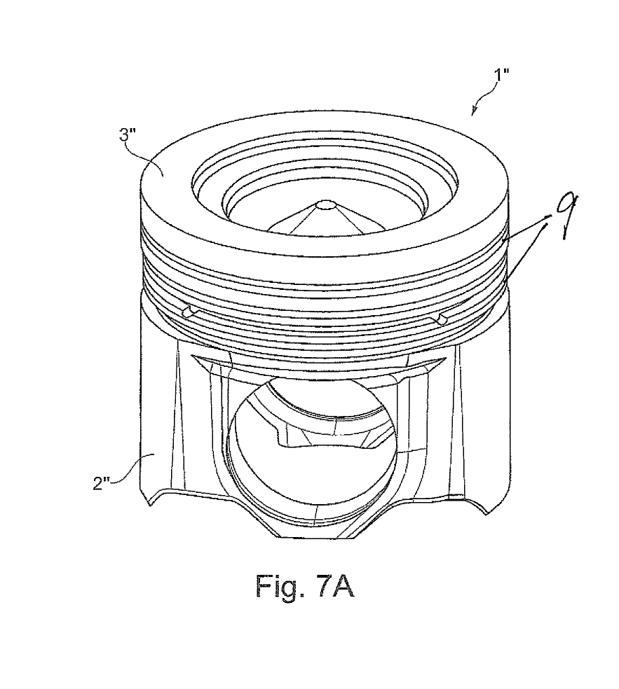

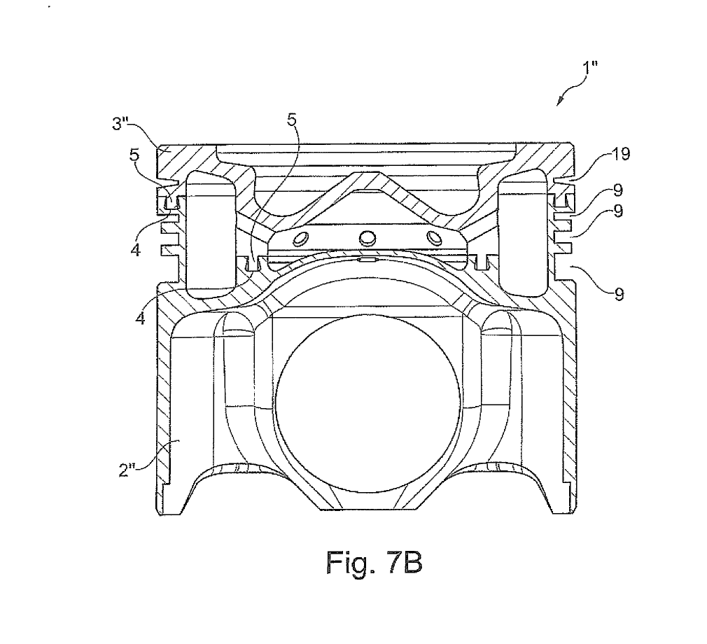

FIGS. 7A and 7B show a perspective view of a finished piston and a cross-sectional view respectively of a finished piston from FIG. 5.

### DETAILED DESCRIPTION

FIGS. 1 to 4B show a first aspect of a piston, and FIGS. 5 to 7B show a further aspect of a piston. The same reference numerals are used for identical elements in both aspects.

In the description of the drawing figures that follows, terms such as top, bottom, left, right, front, rear refer solely to the representation selected as an example and the position of the device and other elements in the respective drawing figures. These terms are not be understood in a restrictive sense, that is to say, these terms can change as the result of different positions and/or mirror-image layout or similar.

FIG. 1 shows an upper part 3 (configured here as a turned part) and a lower part 2, configured as a forged lower part 2, of a piston 1. Naturally, other production methods and combinations are conceivable.

A radially circumferential groove 4 in the lower part 2, configured as a dovetail groove, is recognizable in the cross-section, wherein two grooves 4 located radially and concentric to each other are present. Alternatively, only one groove 4 or more than two grooves 4 may be present. Matching tongues 5 are present in the upper part 3 that engage the groove 4 which is configured as a dovetail groove when the upper part 3 is joined to the lower part 2. Other geometric shapes are similarly conceivable for the groove 4. It is further shown that the area 6 of the upper part 3 is heated before joining is carried out. Specifically involved are the tongue 5, or the tongues 5, that are to engage the dovetail groove 4, or the dovetail grooves 4. Alternatively, or supplementally, the groove itself 4 can be heated.

FIGS. 2A and 2B show the state in which the upper part 3 is squeezed, or pressed, onto the lower part 2. In upper illustration of FIG. 2A the upper part 3 has not been pressed completely onto the lower part 2. This can be recognized by the fact that the downward pointing tongues 5 have not yet been pressed completely into the groove 4 and have not yet been deformed. Not until the upper part 3 has been further squeezed, or pressed, towards the lower part 2, do the tongues 5 of the upper part 3 become deformed in the grooves 4 of the lower part 2, as can be seen in FIG. 2B. The joining surfaces 7 of the upper part 3 (that face each other) also rest completely on the matching surfaces of the lower part 2. The joining direction is identified in FIGS. 2A and 2B with the reference letter F.

FIGS. 3A and 3B show a piston blank 8 designed and joined in accordance with FIGS. 1 and 2 that still has to be taken for final machining before it can be installed in the cylinder of an internal combustion engine.

FIGS. 4A and 4B finally show the finish-machined completed piston 1 into which ring grooves 9 and valve pockets 10 have been worked or formed. In addition, the inner area of the combustion bowl 11 was also machined. It should be mentioned at this point that the dividing plane 12 between upper part 3 and lower part 2 is stepped, but can also lie in the same plane. In addition, various possibilities exist with respect to the dividing plane 12 between the upper part 3 and the lower part 2. In FIG. 4B, a dividing plane 12 (viewed from above) can be seen between the topmost and the center ring groove. The outer dividing plane 12 can, however, also lie above or below both grooves. In addition, a cooling gallery piston is shown in FIGS. 4A and 4B that has a radially circumferential cooling gallery 13 concentric around the combustion bowl 11. A cooling gallery 13 of this kind can, but does not have to, be present. The same applies to the combustion bowl 11. The type of configuration is not limited to one such as is shown in FIGS. 4A and B. With this type of configuration, the finished piston 1 has two oppositely located skirt sections 14 that bear against the cylinder wall of the internal combustion engine when the piston 1 is operating. The two load-bearing skirt sections 14 are linked by recessed connecting walls 15, wherein the piston pin bore 16 is disposed in the connecting walls 15 in an intrinsically known way. Naturally, other types of construction for internal combustion engine pistons are conceivable in addition to this type of construction to which the method and the described configuration can be applied.

FIG. 5 shows an alternative aspect of a piston blank 8′ for the upper part 3′ of the piston in accordance with FIGS. 1 to 4B, where it can be seen that transfer bores 17 are present in this upper part 3′. By means of these transfer bores 17, it is possible to exchange a cooling medium between the radially circumferential outer cooling gallery 13 and the internally located, inner area 18 of the piston. In such a case the piston has an outer (here radially circumferential) cooling gallery 13 and an inwardly located, inner area 18 configured as a cooling space. By reason of the arrangements of the transfer bores 17 shown, the transfer bores 17 can be introduced more easily into the upper part 3′ and deburred better after the transfer bores 17 have been introduced.

FIGS. 6, 7A and 7B show a variant of a piston 1″ that is directed specially at the requirements in commercial vehicles. FIG. 6 shows the piston blank 8″ after the upper part 3″ and the lower part 2″ have been joined. It is particularly noticeable here that the ring grooves 9 and additional recesses 19 above and below the ring grooves 9 have been introduced.

An additional benefit of the method can be seen in the fact that no degradation results in the microstructure in the area of the upper part 3, 3′, 3″ and the lower part 2, 2″ that have been joined. Such weakness occurs to disadvantage particularly with welded joints. Similarly, beads are created disadvantageously with welded or soldered joints (in particular when using friction welding, friction weld beads) which have to be removed to the extent this is even possible based on the design of the piston 1, 1″. If the beads created during welding remain, in particular friction welding beads, in areas that are no longer accessible after the two parts have been joined (e.g. inside the cooling gallery 13) they can have a deleterious effect when the piston 1, 1″ is operating because, for example, the cooling medium can no longer circulate in the cooling gallery 13. The positive-lock joining process overcomes these disadvantages in an advantageous way.

1. A piston for an internal combustion engine comprising at least one lower part and at least one upper part, characterized in that the at least two piston parts have matching geometries in a connecting area to effect a positive-locking joint.

2. The piston from claim 1, wherein:
matching geometries are configured as a groove and a tongue.

3. The piston from claim 2, wherein
the tongue has the profile of a tongue matching the groove at least after the joining process.

4. The piston from claim 2, wherein:
the groove in cross-section has a negative profile of a dovetail profile.

5. The piston claim 2, wherein:
the tongue at least following the joining process, has a dovetail profile in cross-section.

6. The piston from claim 1, wherein:
the at least one lower part and the at least one upper part are permanently and inseparably connected following completion of the positive-locking procedure.

7. A method for producing a positive-locking connection between a lower part and an upper part of a piston, for an internal combustion engine, characterized in producing the positive-locking connection in one procedural step using a joining device.

8. The method from claim 7, wherein:
heating at least one of the at least one upper part and the at least one lower part prior to joining to a higher temperature than ambient temperature.

9. The method from claim 8, wherein:
forming matching geometries of the at least one upper part and the at least one lower part as a tongue and a groove, and wherein the tongue assumes the shape of the groove during the joining process.

10. The method from, wherein:
creating an inseparable positive locking connection between the at least one lower part and the at least upper part of a piston by hot forming.
